(19) United States
(12) Patent Application Publication
(10) Pub. No.: US 2006/0027687 A1
(43) Pub. Date: Feb. 9, 2006

(54) Method and device for cold gas spraying

(75) Inventors: Peter Heinrich, Germering (DE); Heinrich Kreye, Hamburg (DE); Thorsten Stoltenhoff, Wentorf (DE); Tobias Schmidt, Eslohe (DE); Ralf Borchert, Prebitz (DE); Reinhard Ballhom, Darmstadt (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/119,724

(22) Filed: May 3, 2005

(30) Foreign Application Priority Data
May 4, 2004 (DE) 10 2004 021 846.3
Jun. 17, 2004 (DE) 10 2004 029 354.6

(51) Int. Cl. B02C 19/06

(52) U.S. Cl. 241/5; 241/40

(57) ABSTRACT

A method and a device for cold gas spraying. According to the invention, energy is supplied to the particles with microwave technology. For that purpose, the nozzle in which the gas jet and particles are accelerated is surrounded by a microwave waveguide and/or a/the microwave waveguide encloses at least in part the spray-free jet between the nozzle outlet and the substrate. Advantageously, one section of the nozzle outlet is made of a ceramic.

This application claims the priority of Federal Republic of Germany patent document nos. 10 2004 021 846.3, filed May 4, 2004, and 10 2004 029 354.6, filed Jun. 17, 2004, the disclosures of which are expressly incorporated by reference herein.

### BACKGROUND AND SUMMARY OF THE INVENTION

The invention involves a method for cold gas spraying in which particles are accelerated in a gas jet and the particles strike a work piece at high speed, and in which the gas jet is accelerated by decompression in a nozzle and is thereby cooled. The invention also involves a device for cold gas spraying comprising a nozzle which is divided into a convergent-input nozzle section and a nozzle outlet.

In cold gas spraying, a gas is accelerated in a Laval nozzle to supersonic speed. The coating material is injected into the gas jet as a powder before or after the nozzle neck and accelerated onto the substrate. The particles accelerated to high speed form a dense and firmly adhering layer on impact. For this purpose the particles have to be deformed. Heating the gas jet increases the gas flow speed and therefore also the particle speed. The heating of the particles also associated therewith encourages deformation on impact. The gas temperature is, however, well below the melting temperature of the coating material so that the particles in the gas jet cannot melt. Compared to the thermal spraying process, the disadvantages connected with melting such as oxidation and other phase changes can be avoided in cold gas spraying.

The cold gas spray method is disclosed in EP 484 533. It has recently been shown that dense and firmly adhering layers occur not only when the gas is accelerated in a Laval nozzle to supersonic speed but also when the gas is only accelerated to speeds close to sonic speed. A method with acceleration to speeds close to sonic speed is included in DE 101 19 288. A Laval nozzle is divided into a convergent section which ends in the nozzle neck and a divergent section beginning at the nozzle neck. A nozzle in which gas is accelerated almost to sonic speed is divided into a convergent section, which ends in the nozzle neck and an adjoining section at the nozzle neck that is shaped conically or cylindrically.

It is best for the layer if the particles are warm (but not melted) when they impact the substrate since this aids plastic deformation. Melting the particles may cause a detrimental change in the properties of the coating. Practical application has shown that the particles heat up well in the hot gas jet and reach temperatures close to the gas temperature. In the second section of the nozzle, the nozzle outlet, and in the spray-free jet between the nozzle outlet and the substrate, the particles cool down again very rapidly. On impact, the heat which promotes plastic deformation is therefore lost. This can adversely affect the properties of the layer. Cooling can be attributed to the fact that the gas acceleration takes place in the nozzle outlet and the gas acceleration is accompanied by gas cooling. In the case of many nozzle geometries, the gas temperature at the nozzle outlet is far below the freezing point. Since the particles react very readily with the gas jet, the temperature of the particles also drops sharply.

The invention is based on the task of finding a method and a device which make possible a comparatively high temperature when the particles impact the substrate.

The task is fulfilled for the method according to the invention by energy being supplied to the particles via microwave technology. The particles are heated by the energy supplied using microwave technology. Hotter particles deform better than colder particles when impacting the workpiece since, in addition to the kinetic energy of the particles, their thermal energy is also available for forming the layer. This improves the quality of the coating in terms of the properties of the layer and its adhesion to the substrate. The increase in the available energy leads to improved adhesion of the particles to the substrate and to one another. With the method of the invention, the heat loss which the particles experience due to the drop in gas temperature that results from the acceleration of the gas jet, is at least partly compensated. The heat loss is preferably not only captured by the entry of energy via the microwave technology but the particles are also heated to over the output temperature present before the nozzle neck. Since heat favors plastic deformation, the more the particles are heated, the more readily they deform on impact. As long as the temperature of the heated particles is below their melting point, a coating or structural part is formed with properties typical of cold gas spraying. If, during heating, temperatures above the melting point of the particles are reached, the particles are fused together or completely melted. Melting the particles changes the properties of the coating, especially with respect to stress ratios in the coating. In different cases, however, coatings which are formed from particles fused together or completely melted particles may be beneficial.

It is especially advantageous if the energy is supplied to the particles in the nozzle. The heat loss which the particles experience in the nozzle due to the cooling of the gas jet is partly compensated, fully compensated or over-compensated where the particle cooling occurs which can be attributed to the acceleration of the gas in the nozzle and the cooling associated therewith. Consquently, the temperature of the particles only drops a little and extreme variations are avoided.

It is more advantageous if the energy is supplied to the particles after they have left the nozzle. For this purpose there are two possible configurations. In the first, the energy is supplied to the particles in the nozzle and after they leave the nozzle. This configuration provides a particularly long time span available for heating. This is an advantage if the particles are to be highly heated or do not heat up readily or if the microwave technology only delivers a low output. In the second configuration, energy is supplied to the particles only after they leave the nozzle. In this case the advantage is that the microwave waveguide does not have to surround the nozzle and is also not affected by the nozzle in terms of its properties.

In an advantageous embodiment, metallic particles or non-metallic particles are used which absorb microwaves. If the particles absorb microwave radiation, the particles are heated by a direct interaction with the microwaves. Metallic particles absorb microwaves and are suitable as a coating material. Of the non-metallic particles that absorb microwaves, silicon carbides and zirconium oxides are particularly suitable as a coating material.

Advantageously, the particles strike the substrate at a temperature of 10 to 800° C., preferably 20 to 500° C., and especially preferably 100 to 400° C. If the temperature of the spray particles is between approximately room temperature and the values indicated in the range of several hundred degrees Celsius, the particles are well heated so that they readily deform on impact but still do not usually melt so that coatings typical of cold gas spraying are produced.

Especially advantageously, the energy is supplied at a frequency of 915 MHz, 2.45 GHz and/or 5.8 GHz. Microwave radiation of these ISM frequences can be handled especially well and are suitable for heating the particles.

The task for the device according to the invention is fulfilled by the nozzle being at least partly surrounded by a microwave waveguide (6) and/or a/the microwave waveguide (6) at least partly enclosing the spray-free jet between the nozzle outlet (3) and the substrate. According to the invention, the nozzle is thus at least partly surrounded by a microwave waveguide and/or a/the microwave waveguide adjoins the nozzle outlet either directly or at a distance. The device according to the invention therefore has the advantages cited above.

In an advantageous form, at least one section of the nozzle outlet is produced from a ceramic, preferably aluminum oxide.

Furthermore, the microwave waveguide advantageously surrounds at least the ceramic section of the nozzle outlet. The microwaves penetrate the ceramic section with a particularly low loss and are absorbed by the particles inside the nozzle, so that the particles heat up.

In an advantageous form, the nozzle outlet is designed with a divergent or cylindrical or conical input. Such nozzle geometries are particularly well suited for cold gas spraying.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an example of an embodiment in which the nozzle is surrounded to a large extent by a microwave waveguide.

FIG. 2 shows an example of an embodiment in which a part of the nozzle outlet and the path of the particles from the nozzle to close to the substrate is surrounded by a microwave waveguide.

### DETAILED DESCRIPTION OF THE DRAWINGS

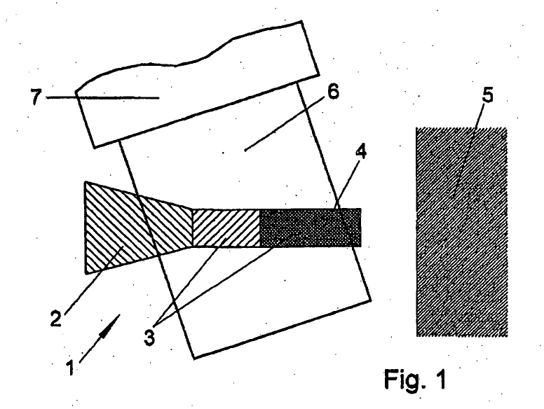

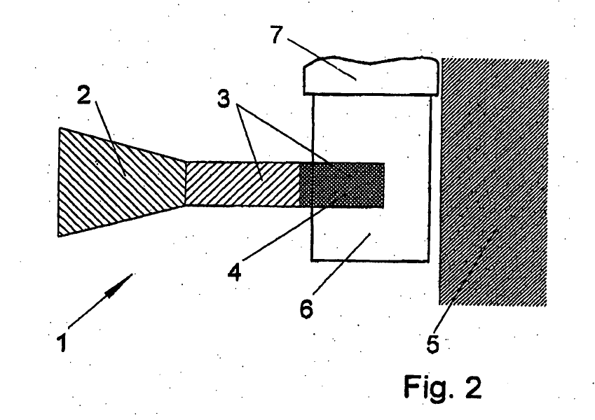

FIGS. 1 and 2 contain nozzle 1 with convergent nozzle section 2 and nozzle outlet 3 and ceramic section 4 as well as substrate 5 and microwave waveguide 6 with connection 7 to a microwave source.

In the example of embodiment in FIG. 1, nozzle 1 is divided into convergent nozzle section 2 which passes into nozzle outlet 3 at the nozzle neck. The nozzle is introduced into microwave waveguide 6. Microwave waveguide 6 is connected via connection 7 to the microwave source. In a part of the nozzle, which here includes most of nozzle outlet 3 and extends to the end of the nozzle, the metallic substance from which nozzles are normally made is replaced by a ceramic. The microwaves of microwave waveguide 6 now penetrate into the nozzle In this ceramic section of the nozzle outlet 4 while the metal substance of the nozzle shields the microwaves. Inside the nozzle, the microwaves are absorbed by the particles and the particles heat up. The heated particles strike substrate 5 and there form a coating.

In the example of embodiment in FIG. 2, the metallic substance is only replaced by a ceramic in a small area at the end of nozzle outlet 3. This ceramic section 4 is surrounded by microwave waveguide 6 along almost the entire path traveled by the particles as a spray-free jet between the nozzle output and substrate 5. The particles are thereby heated on the last piece in the nozzle and after the nozzle output until just before substrate 5.

In these examples of embodiment, a microwave waveguide is used to advantage which is configured as a rectangular microwave waveguide. Microwave waveguides are used to transfer microwaves over short distances. Particles which move in the microwave waveguide absorb the microwaves and thereby heat up. In the rectangular microwave waveguide, a standing wave develops which is particularly well suited for transferring energy. This is advantageously operated at ISM frequences.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

List of Diagram References

1 nozzle
2 convergent nozzle section
3 nozzle outlet
4 ceramic section of the nozzle outlet
5 substrate
6 microwave waveguide
7 microwave waveguide connection to the microwave source

What is claimed is:

1. Method for cold gas spraying wherein particles are accelerated in a gas jet and the particles strike a substrate at high speed, and wherein the gas jet is accelerated by decompression in a nozzle and cooled, characterized in that energy is supplied to the particles via microwave technology.

2. Method according to claim 1, wherein energy is supplied to the particles in the nozzle.

3. Method according to claim 1, wherein energy is supplied to the particles after they have left the nozzle.

4. Method according to claim 1, wherein metallic particles or non-metallic particles which absorb microwaves are used.

5. Method according to claim 1, wherein the particles strike the substrate at a temperature of 10 to 800° C., preferably 20 to 500° C. and especially preferably 100 to 400° C.

6. Method according to claim 1, wherein the energy is supplied at a frequency of 915 MHz. 2.45 GHz and/or 5.8 GHz.

7. Device for cold gas spraying including a nozzle which is divided into a convergent-input nozzle section and a nozzle outlet, characterized in that the nozzle is surrounded at least in part by a microwave waveguide and/or a/the microwave waveguide encloses at least in part the spray-free jet between the nozzle output and the substrate.

8. Device according to claim 7, wherein at least one section of the nozzle outlet is made of a ceramic (4), preferably aluminum oxide.

9. Device according to claim 7, wherein the microwave waveguide surrounds at least the ceramic section of the nozzle outlet.

10. Device according to claim 7, wherein the nozzle outlet has an input with a divergent or cylindrical or conical shape.
